(19) United States
(12) Patent Application Publication
(10) Pub. No.: US 2024/0372115 A1
(43) Pub. Date: Nov. 7, 2024

(54) FLOW FIELD PLATE AND METHOD FOR OPERATING A FLOW FIELD PLATE

(71) Applicant: Schaeffler Technologies AG & Co. KG, Herzogenaurach (DE)

(72) Inventors: Sebastian Zwahr, Obermichelbach (DE); Thomas Sponsel, Heiligenstadt (DE)

(21) Appl. No.: 18/683,753

(22) PCT Filed: Jul. 11, 2022
(86) PCT No.: PCT/DE2022/100493

§ 371 Date: Feb. 14, 2024

(30) Foreign Application Priority Data
Aug. 18, 2021 (DE) 10 2021 121 404.1

(51) Int. Cl. H01M 8/0265; H01M 8/026; H01M 8/0267

(52) U.S. Cl. CPC H01M 8/0265; H01M 8/026; H01M 8/0267

(57) ABSTRACT

A flow field plate (1) comprises two stamped half-plates (2, 3), which lie one on the other and which have a rectangular, elongate basic shape, wherein the half-plates (2, 3) form: —coolant ports (5); —media ports (6, 7), which are located on the long sides of the half-plates (2, 3); —distribution fields (8), which are located next to the ports (5, 6, 7) and are provided for coolant distribution and media distribution; and—active fields (9); and wherein stamped structures (4) are formed within the distribution fields (8) such that there are increasing free flow cross-sections for the media which flow from the port (6, 7) in question toward the port (7, 6) located at the opposite long side.

### CROSS-REFERENCE TO RELATED APPLICATION

The present application is the U.S. National Phase of PCT Patent Application Number PCT/DE2022/100493, filed on Jul. 11, 2022, which claims priority to German Patent Application Number 10 2021 121 404.1, filed on Aug. 18, 2021, the entire disclosures of which are incorporated by reference herein.

### TECHNICAL FIELD

The disclosure relates to a bipolar plate composed of two embossed half-plates for a fuel cell. Furthermore, the disclosure relates to a method for producing a bipolar plate.

### BACKGROUND

Various bipolar plates for fuel cells are known, for example, from the publications DE 10 2017 130 489 A1 and WO 2018/141319 A1. The known bipolar plates comprise a first corrugated plate having a hole pattern and a second plate arranged on the corrugated plate in a sealing manner. The hole pattern of the first plate is provided for passage of a gas substantially transverse to the waveform. The bipolar plates thus provided are optimized in particular with regard to flow distribution.

A further bipolar plate for an electrochemical system is known, for example, from DE 20 2016 107 302 U1. The known bipolar plate is composed of half-plates, which are referred to as separator plates. The separator plates have through holes for the passage of a medium. A distribution or collection region of the separator plates is provided with a plurality of webs through which channels are formed that are in fluid communication with the through hole. Furthermore, a flow field is formed by the separator plates, which is in fluid communication with the through opening via the distribution or collection region and has guide structures for guiding a medium through the flow field. In addition, a continuous, lowered transition region exists, which is arranged between the distribution or collection region and the flow field. In the device according to DE 20 2016 107 302 U1, flow-conducting structures within the transition region have a height that is less than the height of structures in the flow field, wherein the height is to be measured perpendicular to the planar surface plane of the separator plate in each case.

A method for producing a separator plate for a fuel cell is known from EP 3 529 842 B1. As part of this method, a material mixture is used that contains carbon powder as the main component and, in addition, various plastic components.

DE 10 2017 118 319 A1 discloses a coating for a bipolar plate that can be used in a fuel cell or in an electrolyzer. The proposed coating is a homogeneous or heterogeneous solid metallic solution containing a noble metal and a non-metallic chemical element.

### SUMMARY

The disclosure is based on the object of further developing bipolar plates for fuel cells compared with the aforementioned prior art with regard to fluidic or flow-related and production-related aspects.

This object is achieved according to the disclosure by a bipolar plate having the features of claim 1. Likewise, the object is achieved by a method for producing a bipolar plate according to claim 7. The embodiments and advantages of the disclosure explained below in connection with the production method also apply, mutatis mutandis, to the device, i.e., the bipolar plate, and vice versa.

The bipolar plate is composed of two embossed half-plates, which lie one on top of the other and which have a rectangular, elongated basic shape, wherein by means of the half-plates coolant ports as well as media ports placed on the longitudinal sides of the half-plates are formed. Next to the ports, there are also distribution fields formed by the half-plates and provided for coolant distribution and media distribution, as well as active fields arranged on both sides of the bipolar plate.

Within the distribution fields, embossings of the half-plates are formed such that increasing free flow cross-sections are provided for the media flowing from the respective port in the direction of the port arranged on the opposite longitudinal side of the bipolar plate and intended for the passage of another medium of the fuel cell. The targeted widening of flow cross-sections thus achieved makes it possible to achieve a particularly uniform flow of media through the fuel cell, i.e., an oxygen-containing gas, in particular air, and a further gas containing hydrogen.

The increasing flow cross-sections are implemented in particular by a decreasing height of the coolant channels formed between the half-plates in the transverse direction of the half-plates. In addition or alternatively, the variation of the flow cross-sections can be achieved by different surface areas of embossed elements that guide the flow. If different embossing depths are provided, the height of an edge channel that is fluidically connected to a media port and is furthest away is, for example, at least 15% greater than the height of the nearest media channel located in the distribution field and supplied by the same port.

According to various possible embodiments, a fluidic connection is provided between the edge channel and a bypass running parallel to the active field. The bypass does not contribute to the generation of electrical power. The flow through the bypass, which is facilitated by the enlargement of the cross-section of the edge channel, is nevertheless accepted, since the particularly low-resistance supply of the edge channel with flowing medium is considered advantageous in terms of a uniform utilization of the active field.

The distribution field does not necessarily have a uniform structure over its entire surface. For example, the distribution field comprises a transverse distribution region adjoining the ports and a longitudinal distribution region arranged between this region and the active field. The terms “transverse distribution region” and “longitudinal distribution region” are intended to express that the medium, i.e., typically gas, is distributed in the regions concerned mainly in the transverse direction or longitudinal direction, respectively, of the overall elongated bipolar plate.

The transverse distribution region can, for example, be designed as a dimpled field and thus be characterized by a particularly good mixing effect. In addition, the dimpled field can be designed in such a manner that it can be flowed through in the transverse direction of the half-plates and thus the entire bipolar plate with a particularly low resistance. Accordingly, the transverse direction can represent the preferred direction of at least a section of the distribution field. The longitudinal distribution region, on the other hand, exhibits, for example, a groove structure with substantially straight grooves running in the longitudinal direction of the bipolar plate and optionally fanning out toward the active field, through which individual channels are formed.

The bipolar plate can be produced by embossing two half-plates in such a manner that each half-plate has non-uniform embossing depths over its width and joining the two half-plates lying on top of one another in order to form a bipolar plate which has coolant channels of non-uniform height between the half-plates. In this regard, the main flow direction of the coolant corresponds to the longitudinal direction of the half-plates during operation of the bipolar plate, wherein the two outer surfaces of the half-plates facing away from the coolant channels delimit media channels which likewise have a non-uniform height corresponding to the non-uniform embossing depth of the half-plates and are designed to conduct media both in the main flow direction and in the transverse direction. Here, a media flow cross-section widens continuously or discontinuously in the transverse direction starting from a port which is formed by openings made in the half-plates.

Within the context of a possible embodiment of the production method, the two half-plates, which are typically not completely mirror-symmetrical with respect to one another, are placed one on top of the other in such a manner that a flow channel for a first medium flowing with a flow component, i.e., a component of movement, in the first transverse direction is formed on an outer surface of the first half-plate, wherein at the same time a flow channel for a second medium flowing with a flow component, in particular the main flow direction, in the opposite transverse direction is formed on the opposite outer surface of the second half-plate, and the flow channels extending in opposite directions to one another have a height which increases in the direction of the beginning of the respective other flow channel.

### BRIEF DESCRIPTION OF THE DRAWINGS

Several exemplary embodiments of the disclosure are explained in more detail below by means of drawings. In the figures:

FIG. 1 shows a section of a bipolar plate of a fuel cell in a plan view,

FIG. 2 shows a detail of the bipolar plate according to FIG. 1 and other fuel cell components in a sectional view,

FIGS. 3 and 4 show details of further bipolar plates in a schematic view.

### DESCRIPTION OF EMBODIMENTS

Unless otherwise stated, the following explanations relate to all exemplary embodiments. Parts that correspond to each other or have basically the same effect are marked with the same reference symbols in all figures.

A bipolar plate marked overall with the reference symbol 1 is part of a fuel cell stack 10, also referred to simply as a stack, which comprises a plurality of similar fuel cells 11. In this regard, each bipolar plate 1 can be attributed to two fuel cells 11. With regard to the principal function of the fuel cell stack 10, reference is made to the prior art cited at the outset.

The bipolar plate 1 is composed of two half-plates 2, 3, each of which has an embossed structure 4. Overall, the bipolar plate 1 has the shape of an elongated rectangle, the longitudinal direction of which is indicated with LR and the transverse direction with QR. A center plane at which the two half-plates 2, 3 lie on top of one another is designated with ME. In typical applications, the bipolar plate 1 is aligned vertically.

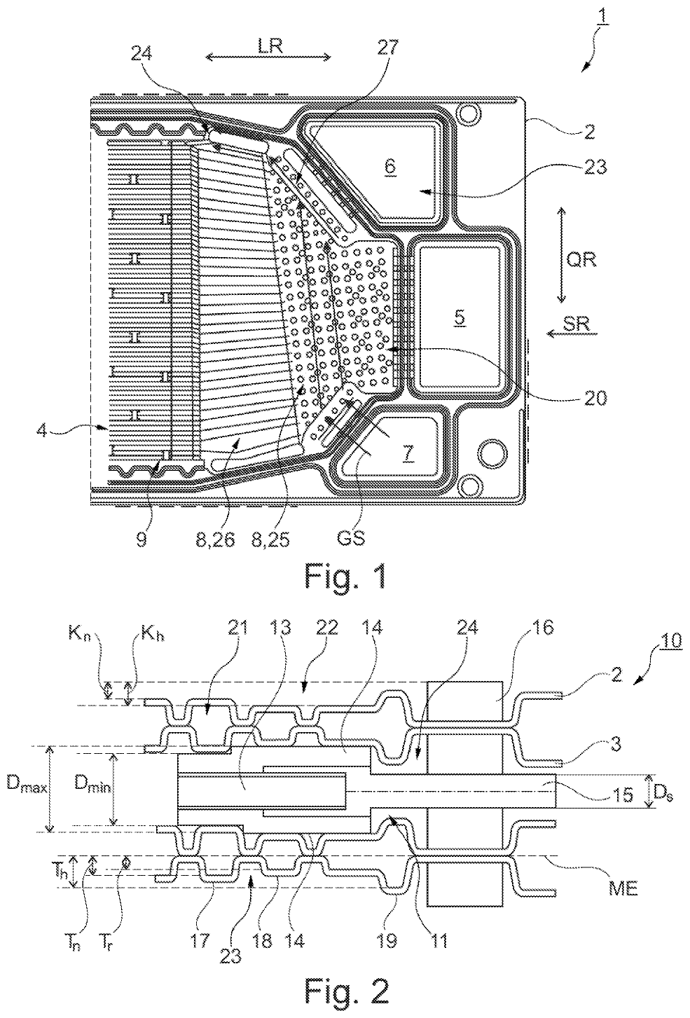

In a basic concept known per se, the bipolar plate 1 has various ports 5, 6, 7, namely coolant ports 5 and media ports 6, 7. In the present cases, the coolant port 5 adjoins a narrow side of the bipolar plate 1, whereas the media ports 6, 7, which are arranged adjacent to the coolant port 5 and through which substances required to operate the stack 10, that is, to generate electrical energy, flow, adjoin the longitudinal sides of the bipolar plate 1. The ports 5, 6, 7 visible in FIG. 1 are used for introducing cooling water or media. In addition, there are three further ports for discharging the cooling water or media. In the present case, gaseous media are referred to, even if liquid substances flow through the ports 6, 7 in some cases.

The various ports 5, 6, 7 are adjoined by a distribution field 8 which, in the flow direction SR of the media, transitions into an active field 9 in which the desired electrochemical reactions take place. For this purpose, a membrane arrangement, designated with 12 overall, is located in the active field 9, which comprises a Catalyst Coated Membrane 13 (CCM) and a gas diffusion layer 14. The membrane arrangement 12 further includes a frame 15, which is also referred to as a sub-gasket. A seal that seals the frame 15 from the bipolar plate 1 is designated with 16.

The embossed structures 4 of the half-plates 2, 3 are largely designed as mirrored to one another and comprise embossed elements 19 of normal embossing depth Tₙ, as well as embossed elements 18 of reduced embossing depth Tᵣ and embossed elements 19 of increased embossing depth Tₕ. Coolant channels 21 are formed between the embossed elements 17, 18, 19 of the first half-plate 2 and the embossed elements 17, 18, 19 of the second half-plate 3. At the same time, flow channels 22, 23 for the flow of the various media, in particular oxygen and hydrogen, are formed on the outer sides of the half-plates 2, 3, i.e., on the surfaces of the half-plates 2, 3 facing away from the coolant channels 21. The different embossing depths Tᵣ, Tₙ, Tₕ have a direct effect on the channel heights Kₙ, Kₕ of the media channels 22, 23, wherein Kₙ stands for a normal channel height and Kₙ for an increased channel height in comparison.

The channel heights Kₙ, Kₕ that can be used during operation of the fuel cell 11 further depend on the geometry of the membrane arrangement 12, wherein in FIG. 2 a minimum thickness of the membrane arrangement 12 is designated with Dₘᵢₙ and a maximum thickness of the membrane arrangement 12 is designated with Dₘₐₓ.

As shown in FIG. 1, the distribution field 8 is composed of two differently structured regions 25, 26, namely a transverse distribution region 25 and a longitudinal distribution region 26. The gas flow, generally designated with GS, has a substantial or principal component of movement in the transverse direction QR in the transverse distribution region 25, whereas in the longitudinal distribution region 26 the gas flows substantially in the longitudinal direction LR. In the case outlined in FIG. 1, the embossed structure 4 in the transverse distribution region 25 is designed as a dimpled embossing 20. In the longitudinal distribution region 26, the embossed structure 4 has a groove form, wherein the grooves formed by the embossed structure 4 widen in a fan shape in the direction of the active field 9.

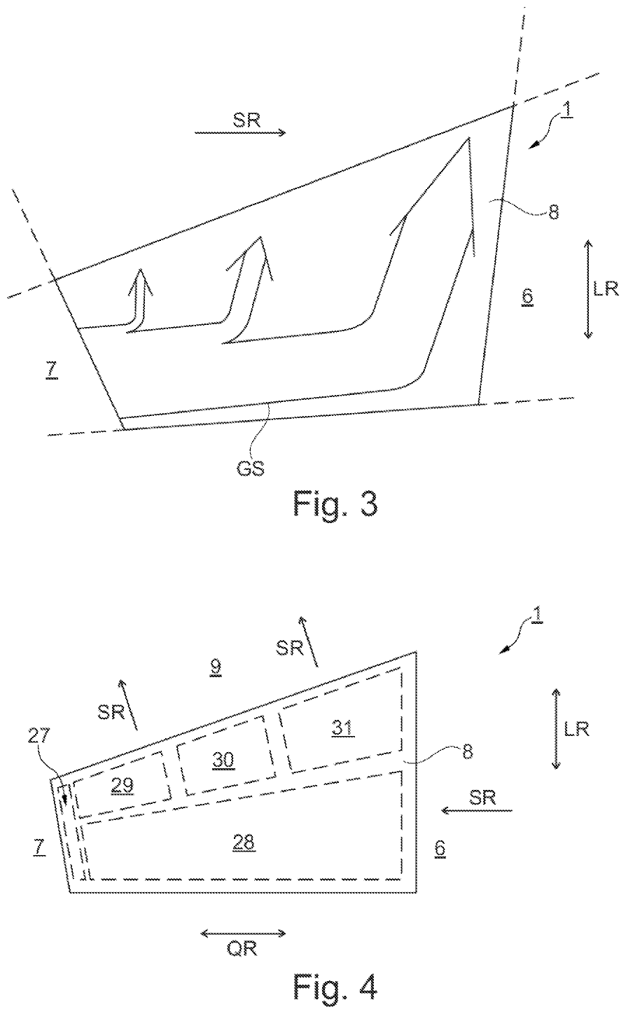

In all exemplary embodiments, the embossed structure 4 in the distribution field 8 is designed in such a manner that gas flows GS from one media port 6, 7 to the opposite media port 7, 6, i.e., mainly in the transverse direction QR, are facilitated in a targeted manner compared to conventional structured plates of electrochemical equipment. In both the case of FIG. 2 and FIG. 3, the gas flows mainly from left to right. As shown in FIG. 2, the channel heights Kₙ, Kₕ increase significantly from left to right, i.e., in the flow direction SR, until close to the seal 16. In this manner, an edge channel 27 is formed which runs close along the media port 6 and is thus particularly far away from the media port 7 into which the flowing medium is introduced. From the edge channel 27, an open connection to a bypass 24 exists that bypasses the active field 9. The gas flowing through the bypass 24 does not contribute to the generation of electrical energy. This is accepted in all present cases. The main advantage of the facilitated gas flow through the edge channel 27 is the optimized media supply in the edge regions of the active field 9.

As far as the improved media supply in the edge regions of the active field 9 is concerned, reference is also made to FIG. 3, which schematically shows the distribution of the gas flow GS within the distribution field 8. Here, thin arrows represent a gas flow GS with high flow resistance and thicker arrows represent a gas flow GS with low flow resistance. As shown in FIG. 3, the further the distance from the media port 7 to the active field 9, the easier the gas flows. The enlarged flow cross-section of the edge channel 27, which is located in the region of the thickest arrow in FIG. 3, i.e., within the distribution field 8 in the right-hand region, contributes to this in a significant manner. The result is a uniformity of the gas flow through the active field 9 over its entire width.

This also applies to the variant shown in FIG. 4, in which, in contrast to FIG. 3, the gas flows from right to left, i.e., is first introduced into the media port 6 on the right. In the case of FIG. 4, there are various sub-fields 28, 29, 30, 31 within the distribution field 8, which differ from one another with regard to the flowability, i.e., the pressure drop occurring during operation of the fuel cell 11. A low pressure drop is provided here within the sub-field 28, which extends over almost the entire width of the distribution field 8 and is particularly designed for flow in the transverse direction QR.

Compared to the sub-field 28, the flow resistance in the edge channel 27, which adjoins the sub-field 28 and at the same time runs parallel to an edge of the media port 7, is reduced again. In this manner, gas travels with a low pressure drop from the media port 6 to that edge of the active field 9 which is farthest from the media port 6. The sub-fields 29, 30, 31 are designed by means of the embossed structure 4 in such a manner that an increasing flow resistance is provided in the order mentioned, i.e., from the sub-field 29 to the sub-field 31. Continuous transitions between the sub-fields 29, 30, 31 are also possible. In any case, the highest pressure drop, relative to the length to be flowed through, is present in the region of the sub-field 31. This ensures that gas does not reach the closest regions of the active field 9 from the media port 6 in excessive quantities. Also in the cases of FIGS. 3 and 4, the distribution field 8 has a structure of various embossed elements 17, 18, 19 not shown in detail here.

### LIST OF REFERENCE SYMBOLS

1 Bipolar plate
2 Half-plate
3 Half-plate
4 Embossed structure
5 Coolant port
6 Media port
7 Media port
8 Distribution field
9 Active field
10 Fuel cell stack, stack
11 Fuel cell
12 Membrane arrangement
13 CCM, Catalyst Coated Membrane
14 Gas diffusion layer
15 Frame, sub-gasket
16 Seal
17 Embossed element of normal depth
18 Embossed element of reduced depth
19 Embossed element of increased depth
20 Dimpled embossing
21 Coolant channel
22 Media channel, flow channel
23 Media channel, flow channel
24 Bypass
25 Transverse distribution region
26 Longitudinal distribution region
27 Edge channel
28 Sub-field
29 Sub-field
30 Sub-field
31 Sub-field
Dₘₐₓ Maximum thickness of the membrane arrangement
Dₘᵢₙ Minimum thickness of the membrane arrangement
Dₛ Sub-gasket thickness
GS Gas flow
Kₙ Normal channel height of a media channel
Kₕ Increased channel height of a media channel
LR Longitudinal direction
ME Center plane
QR Transverse direction
SR Flow direction
Tₕ Increased embossing depth
Tₙ Normal embossing depth
Tᵣ Reduced embossing depth

1. A bipolar plate with two embossed half-plates, which lie one on top of the other and which have a rectangular, elongated basic shape, wherein by means of the half-plates coolant ports as well as media ports placed on the longitudinal sides of the half-plates, distribution fields arranged next to the ports and provided for coolant distribution and media distribution and active fields are formed, and wherein embossed structures are formed within the distribution fields such that increasing free flow cross-sections are provided for the media flowing from the respective port in the direction of the port arranged on the opposite longitudinal side.

2. The bipolar plate according to claim 1, wherein the increasing flow cross-sections are implemented by a decreasing height of the coolant channels formed between the half-plates in the transverse direction of the half-plates.

3. The bipolar plate according to claim 2, characterized in that wherein the height of an edge channel furthest from the associated port is at least 15% greater than the height of the next media channel located in the distribution field and supplied by the same port.

4. The bipolar plate according to claim 3, wherein the edge channel transitions into a bypass flanking the active field.

5. The bipolar plate according to claim 1, wherein the distribution field comprises a transverse distribution region adjoining the ports and a longitudinal distribution region (26) arranged between this region and the active field.

6. The bipolar plate according to claim 5, wherein the transverse distribution region is designed as a dimpled field.

7. A method for producing a bipolar plate, wherein two half-plates are embossed in such a manner that each half-plate has non-uniform embossing depths over its width and the two half-plates are joined lying on top of one another in order to form a bipolar plate which has coolant channels of non-uniform height between the half-plates, wherein the main flow direction of the coolant corresponds to the longitudinal direction of the half-plates, and wherein the outer surfaces of the half-plates facing away from the coolant channels delimit media channels which likewise have a non-uniform height corresponding to the non-uniform embossing depth of the half-plates and are designed to conduct media both in the main flow direction and in the transverse direction, wherein a media flow cross-section widens in the transverse direction starting from a port which is formed by openings made in the half-plates.

8. The method according to claim 7, characterized in that the half-plates are placed one on top of the other in such a manner that a flow channel for a first medium flowing with a flow component in the first transverse direction is formed on an outer surface of the first half-plate, wherein at the same time a flow channel for a second medium flowing with a flow component in the opposite transverse direction is formed on the opposite outer surface of the second half-plate, and the flow channels extending in opposite directions to one another have a height which increases in the direction of the beginning of the respective other flow channel.

9. A fuel cell comprising:
a bipolar plate comprising:
two embossed half-plates, wherein a first embossed half-plate is positioned on top of a second embossed half-plate,
one or more coolant ports;
one or more media ports, wherein the one or more coolant ports and the one or more media ports are positioned on a longitudinal side of the bipolar plate;
one or more distribution fields formed by the first half-plate and the second half-plate and positioned adjacent to the one or more coolant ports and the one or more media ports, wherein the one or more distribution fields are configured for coolant distribution and media distribution within the bipolar plate, wherein embossed structures are formed within the one or more distribution fields such that increasing free flow cross-sections are provided for media flowing from a respective port in the direction of a corresponding port arranged on an opposite longitudinal side of the bipolar plate; and
one or more active fields formed on the first embossed half-plate and the second embossed half-plate.

10. The fuel cell according to claim 9, wherein the increasing flow cross-sections are implemented by a decreasing height of coolant channels formed between the two half-plates in the transverse direction of the two half-plates.

11. The fuel cell according to claim 9, wherein a height of an edge channel furthest from an associated port is at least 15% greater than a height of a next media channel located in the one or more distribution fields and supplied by the same port.

12. The fuel cell according to claim 11, wherein the edge channel transitions into a bypass flanking the one or more active fields.

13. The fuel cell according to claim 9, wherein the one or more distribution fields comprise a transverse distribution region adjoining the one or more coolant ports and the one or more media ports and a longitudinal distribution region arranged between the transverse distribution region and the one or more active fields.

14. The fuel cell according to claim 13, wherein the transverse distribution region comprises a dimpled field.

15. The fuel cell according to claim 11, wherein each half-plate of the bipolar plate has non-uniform embossing depths.

16. The fuel cell according to claim 11, wherein the bipolar plate comprises one or more coolant channels of non-uniform height between the first half-plate and the second half-plate.

17. The fuel cell according to claim 11, wherein a main flow direction of a coolant within the bipolar plate corresponds to the longitudinal direction of the half-plate.

18. The fuel cell according to claim 11, wherein bipolar plate comprises one or more media channels of non-uniform height between the first half-plate and the second half-plate.

19. The fuel cell according to claim 18, wherein the one or more media channels are configured to conduct media in the main flow direction and in a transverse direction.

20. The fuel cell according to claim 19, wherein a cross-section of a media flow widens in the transverse direction starting from a port formed by openings formed in the half-plates.
